(19) United States
(12) Patent Application Publication
(10) Pub. No.: US 2024/0420130 A1
(43) Pub. Date: Dec. 19, 2024

(54) LOCATION-BASED NFTS

(71) Applicant: Datacurve, Inc., Los Altos, CA (US)

(72) Inventors: Rakesh Ramde, Los Altos, CA (US); Amanjyot Singh Johar, Sunnyvale, CA (US)

(73) Assignee: Datacurve, Inc., Los Altos, CA (US)

(21) Appl. No.: 18/669,055

(22) Filed: May 20, 2024

Related U.S. Application Data
(60) Provisional application No. 63/467,700, filed on May 19, 2023.

(51) Int. Cl. G06Q 20/38

(52) U.S. Cl. CPC G06Q 20/389; G06Q 20/3829

(57) ABSTRACT

A user position is tracked with a smart phone or other device or mechanism. NFTs associated with a current position are identified in real-time with movement. Certain NFTs are also related to a current time at the current position. Transactions are recorded in the associated NFTs.

### CROSS-REFERENCE TO RELATED APPLICATIONS

The invention claims priority under 35 USC 119 (e) to 63/467,700, entitled LOCATION-BASED NFTS, and filed May 19, 2023, by Ramde et al., the contents of which are hereby incorporated in its entirety.

### FIELD OF THE INVENTION

The invention relates generally to computer networks, and more specifically, to record user data at a particular location, and can further segregate based on a particular time at the location.

### BACKGROUND

Augmented reality and virtual reality are technologies that tie user experiences to a particular location, whether actual or digital. In augmented reality, enhanced digital information can be superimposed over actual objects, stores, people, and other subjects. For example, when a user walks by a store, through electronic glasses or a mobile phone, a history of previous interactions at the location or commercial offers for the location, can be presented. In virtual reality, the location can be digital, such as in a video game.

At the same time, users can engage with some applications that try to superimpose AR data and techniques to augment their experience as relates to that particular application. For example, a user can wear specialized glasses inside a restaurant and augment what they see with animated characters. However, these are often short lived experiences and repetitive in nature. For example if the user were to wear the same glasses at Golden Gate Bridge, they would likely augment the visuals with similar characters. This is quite boring and also not amenable to transactions between the user, application provider or any third party vendors that may wish to be a part of the ecosystem.

As mobile commerce gains more popularity, and gets intertwined with AR/VR and AI techniques, specially amongst the new generation of users, location based transactions will be ever more important to the users. Not having transactional capabilities at specific physical locations as part of the customer experience will be detrimental for businesses. For example, a ticketing application that in real time engages with fans who are physically present at the venue on the day of the concert is much more desirable than one that does not. Engagement in real time with transactional capabilities could open up revenue opportunities for many applications without the need for redirecting users via separate URLs to a mobile application or a web application to complete the transactions. Further, today's applications are also invasive on a user's privacy. Most applications continuously track user's location information, and associate it with their personally identifiable information. For example, today it is impossible for a user to be transparently rewarded for a visit to a location such as a stadium, arena, or a venue that hosts any events, based simply on their behavior and not on their personally identifiable information. Or for that matter, make those rewards dynamic with each visit. Or to make them useful outside of the limited scope of the application. It is also unheard of for users or venues (or event organizers at such venues) to mix and match location based experiences over a period of time to compose new dynamic experiences for the users.

There is a need for extending physical experiences into the digital realms, and location-based digital experiences can offer enhanced user experiences. Today, there is a need for these digital experiences to be personalized for each individual, based in part on their own engagement with the location in play, and while preserving their own privacy as they do so. What is desirable is to create avenues for commercial transactions, digital or physical, based on a location, while not compromising on the personal information of the users.

Therefore, what is needed is a robust technique for to record user data at a particular location, and can further segregate based on a particular time at the location.

### SUMMARY

To meet the above-described needs, methods, computer program products, and systems for recording user data at a particular location, and can further segregate based on a particular time at the location.

In one embodiment, a user position is tracked with a smart phone or other mechanism. NFTs associated with a current position are identified in real-time with movement. Certain NFTs are also related to a current time at the current position. Transactions are recorded in the associated NFTs.

In one embodiment, the data may include their name, organization, business unit, whether they are identified as tourists, fans, casual travelers, any aspect of their identity or any other information regarding their status with respect to the organization that may implement this invention. In addition to a user wallet, the system may also create a decentralized identity for the users. This decentralized identity can further be associated with the user's external accounts such as third party loyalty rewards programs, social networks or public profiles.

In one embodiment, the system is governed by configurable smart contracts. Smart contracts are self-executing contracts with the terms of the agreement directly written into code. Smart contracts enable automated and tamper-proof agreements, facilitating various applications such as decentralized finance (DeFi), non-fungible tokens (NFTs), and decentralized exchanges (DEXs). It may be desirable from a business and convenience perspective that the digital assets may only be traded and governed by the rules in the smart contract(s). In one embodiment, the digital assets may be blocked from trading on any third party systems, exchanges, protocols etc., thereby making it a singular registry for location based behavioral data for users.

Advantageously, users or businesses could automatically record certain data or behaviors to NFTs based on position and time.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating a system to record user data at a particular location, and can further segregate based on a particular time at the location, according to an embodiment.

FIG. 2 is a more detailed block diagram illustrating an NFT engine of the system of FIG. 1, according to an embodiment.

FIG. 3 is a diagram illustrating an AI dataset marketplace or a business application, according to an embodiment.

FIG. 4 is a block diagram illustrating the elements of the LogicWare with artificial intelligence, blockchain and Web3 interfaces, according to an embodiment.

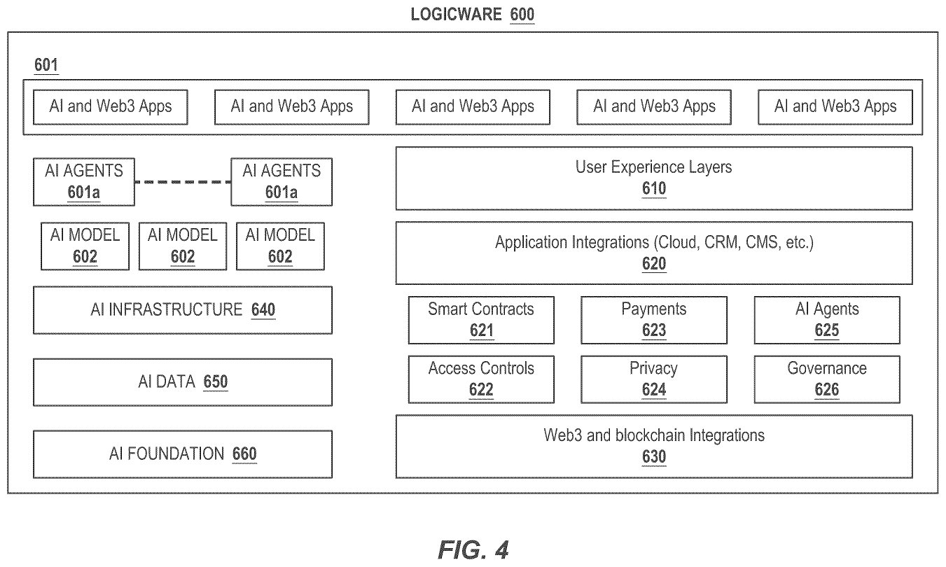

FIG. 5 illustrates the use of verified credentials (VCs) for authentication into the ecosystem of applications for access control or user onboarding features, according to an embodiment.

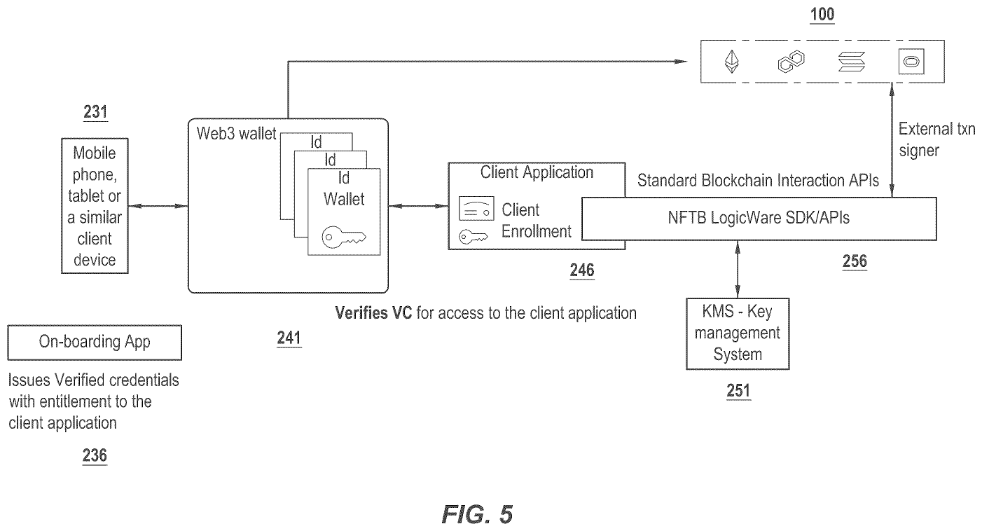

FIG. 6 is a more detailed block diagram illustrating a location transaction module of the system of FIG. 1, according to an embodiment.

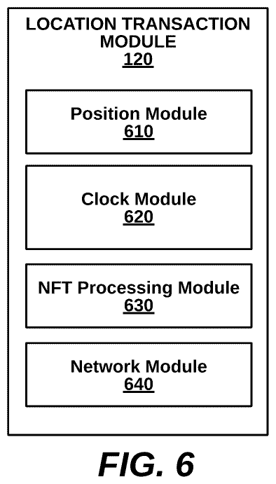

FIG. 7 is a high-level flow diagram illustrating a method for recording user data at a particular location, and can further segregate based on a particular time at the location, according to one embodiment.

FIG. 8 is a more detailed flow diagram illustrating an alternative method for recording user data at a particular location, and can further segregate based on a particular time at the location, according to one embodiment.

FIG. 9 is a block diagram illustrating an example computing device for the system of FIG. 1, according to one embodiment.

### DETAILED DESCRIPTION

Methods, computer program products, and systems for recording user data at a particular location, and can further segregate based on a particular time at the location. One of ordinary skill in the art will recognize many alternative embodiments that are not explicitly listed based on the following disclosure.

Fungible cryptographic tokens are known. For example, one type of fungible token format is the well-known ERC-20 token. Non-fungible cryptographic tokens (NFTs) are known. For example, one type of NFT format is an ERC-721 token. Both are operable with an Ethereum virtual machine (EVM). While the token formats are known, each token can be configured to create unique functionality, unique expressions, or other unique aspects of the token. An NFT is a cryptographic token that represents ownership or other rights of a designated asset, e.g., a digital file or other assets associated with the token. Typically, the digital file or other asset is referenced in metadata in the token definition.

Token creation (e.g., minting) and transactions are typically handled via “smart contracts” and a blockchain (e.g., the Ethereum blockchain) or other distributed ledger technology. NFTs are minted according to known token minting protocols, but each can be configured with their own parameters to create uniqueness between the tokens. With some tokens, the token may be minted on demand when the token creator decides to mint the token. Some fungible tokens are minted and initially allocated via an initial coin offering. Some tokens are “pre-mined” and subsequently allocated or offered for sale. For example, once minted, an NFT can be offered for sale or acquisition via an NFT marketplace or other token sale/distribution platform.

The existing token minting and sale process suffers from various technical drawbacks and limitations. For example, conventional “smart contracts” have numerous advantages but are limited in that typically they can operate only on the data contained inside the nodes of the blockchain on which they run. This makes them like a self-contained system, somewhat closed to external sources. This can be problematic when external data is needed to satisfy conditions of the smart contract.

By using a blockchain-based system and specifically NFTs within standalone applications with location sensing, the user experience could be significantly enhanced. Businesses and brands of all sizes can easily engage with their users via NFTs that can represent giveaways, loyalty rewards, gifts, coupons, vouchers, etc. as users visit certain locations such as a tourist spot, or a stadium for a concert or a game. The decentralized nature of blockchain could also make it more difficult for unauthorized individuals to access or tamper with such NFT based utilities and preserve personalization attributes for the user. Moreover, blockchain-based resource and communication tools could facilitate data sharing between various businesses that may have an interest in and around a specific location. It can also facilitate data sharing between a business and its partners for example, advertisers at a concert venue. Additionally, the use of smart contracts on a blockchain could potentially automate various aspects of the customer experience and customer success programs deployed widely in organizations. Finally, the use of NFTs incentivizes the holders of the NFTs with recognition and rewards while reinforcing positive behaviors, skills or outcomes for natural communities of said businesses, organizations, suppliers, users, and other ecosystem participants, who could all benefit from sharing data in a unique manner.

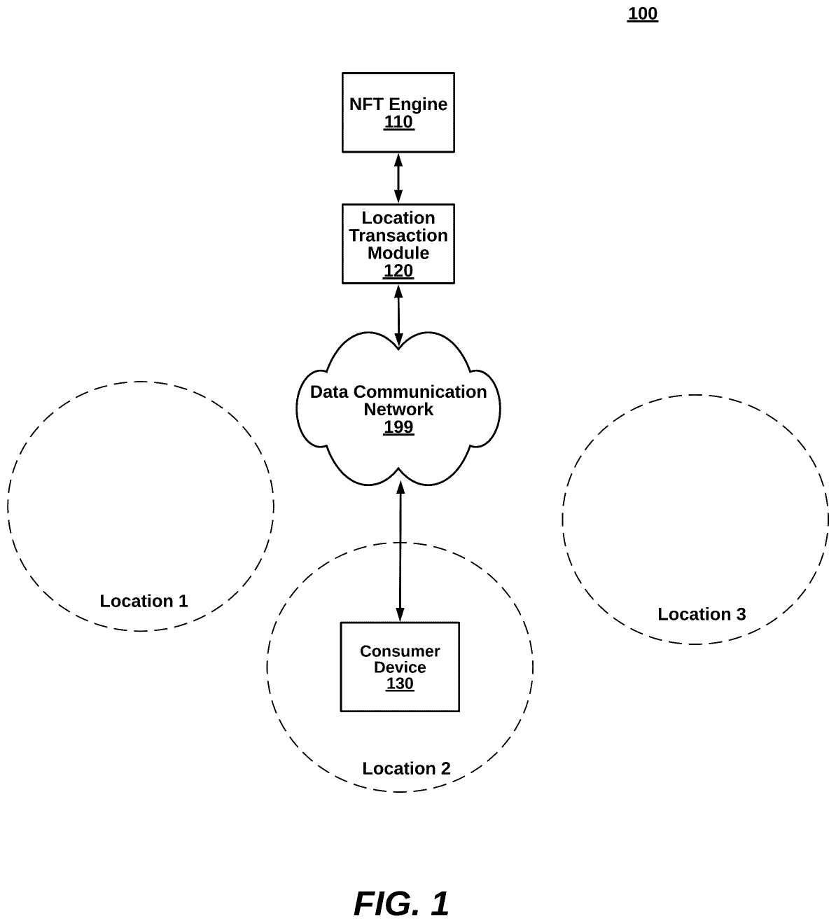

### I. Systems for Location-Based NFTs (FIGS. 1-3)

FIG. 1 is a high-level block diagram illustrating a system 100 for recording user data at a particular location, and can further segregate based on a particular time at the location, according to one embodiment. The system 100 includes an NFT engine 110, a location transaction module module 120 interacting over a data communication network 199 with a consumer device 130, as users of the system 100. In one embodiment, the NFT engine 110 and the location transaction module 120 are integrated into a single physical device, and in another embodiment, communicate across the data communication network 199. Many other variations are possible.

In one embodiment, the NFT engine 110 mints and allocates tokens based on location-triggered events and provides access to token-gated content, in response to a user satisfying specified token criteria. The NFTs can also be minted in accordance with other operational or marketing objectives—for example, as part of a user profile and the user's interaction within an AR/VR enabled application, such as an NFT can be minted when the user device can objectively verify that the user is in a certain location. In another embodiment, an NFT can be minted if the user is a member of a group. In yet another embodiment, the NFT can be minted if the user is a member of a DAO (decentralized autonomous organization). Other ways of minting the tokens include but are not limited to:
a. The application can be embedded into other applications such as games. Users can be rewarded by participating and interacting with other people or players within the application or within a location.
b. The application can be a part of a productivity suite of software or an email client or any other collaborative software. The NFTs can be minted in accordance with corporate policies on rewarding their employees or customers for example at an offsite retreat.
c. The application can be part of a retail, ecommerce, or any other web application. The NFTs can then be minted in accordance with a loyalty program of the platform, or for any other marketing, tracking, or operational objectives.
d. For a standalone application such as a map, the user can redeem NFTs that may potentially be offered or advertised businesses featured in the maps. by Telegram or WhatsApp, the NFT minting can be based on the users's credentials (phone number or email address)

The NFTs can also be minted in accordance with other operational or marketing objectives—for example as part of a customer or voting experience, or as a membership in a DAO (decentralized autonomous organization). In one embodiment, for events and concerts, if fan voting is to be restricted to fans inside the application, the location module can trigger an NFT mint process to give in-stadium fans access to the voting portal. Other ways of minting the tokens include but are not limited to:
1. Live NFT drops during the duration of an event at a specific location such as a sale event that may optionally be tied to other activities in a physical retail location
2. Marketplace NFTs: businesses located in a particular location may mint NFTs or digital assets and make them available on a marketplace. The NFTs in the marketplace may be bought, sold, traded, or redeemed. For authenticity, all such NFTs or digital assets that have been validated by local businesses may rank higher in their authenticity and perceived value. For example, a coffee shop may offer a 20% discount coupon as an NFT if a user has dined at a nearby restaurant.
3. Promotional NFTs and other digital assets for in-venue events that can optionally be integrated with loyalty programs to encourage fan reengagement and reward them with digital assets for their loyalty towards athletes, teams, sponsors, other ecosystem participants or to access highlight reels and other event-based materials;
4. Auctions: The platform can put a specific item up for auction at a particular location, with the highest bidder being awarded an NFT. This can be particularly effective for rare or one-of-a-kind items or experiences;
5. Collaborations: A collaborative NFT may involve collaborating with other brands, artists, or creators to create unique NFTs that combine their styles or content. These can also be sponsored by some advertisers wishing to reach a particular demographic, based on their data and behavioral patterns. For example, a golf apparel company may sponsor an athlete and release a limited set of NFTs featuring the athlete but make it available only to patrons at the Pebble Beach Golf Course.
6. Exclusive releases: This involves releasing a limited number of NFTs for a specific event or occasion, such as a music festival or movie premiere, that may be only accessible in certain locations.

The platforms described in the embodiments take the complexity of the blockchain environment and abstracts it into a set of APIs and SDKs that can manage the entire process easily. For example, crypto wallets are front end technologies that require user interaction and input to mint an NFT from a smart contract. The NFT engine is configured to be backend and middleware technology (LogicWare 600) technology managing the complexity away from the user and providing for interaction via APIs and SDKs. As such any front end application can now interact with the blockchain such as through the AI Foundation 660 without burdening the users with the intricacies of storing or managing their private keys and authorizing transactions to sign transactions to interact with the blockchains and mint, redeem, or create NFTs. A proxy process can be deployed in the backend that abstracts the user signatures as part of the transaction. At the backend, the transactions can also be handled by custodial wallets, or multi-signature wallets that can associate the transactions to the user accounts. The backend is capable of supporting multiple applications simultaneously and while each application may be deployed by a unique customer. The NFT engine 110 maps the backend databases, digital assets, and the blockchain layer interaction to provide a simple workflow for businesses and enterprises.

LogicWare also provides for creating wallets with various ways of protecting the private keys. The private keys can be stored on a Hardware Security Module (HSM), or in Key Management Systems (KMS), whose keys may be further entrusted to an encrypted vault. The keys can also be managed using a multi party computation (MPC) process that enables multiple parties to jointly compute a function without revealing their private inputs to each other. As part of the key management contemplated by this invention, LogicWare can distribute the private key across multiple parties in a way that ensures that no single party has access to the full private key. Instead, each party holds a share of the private key, and only by combining all shares can the full private key be reconstructed. Finally, irrespective of the key security mechanism described above, if at any time, a holder of the private key so desires, they can take complete control of their private keys via LogicWare.

For users of such a system, it is important that the system should be easy to use and also provide for secure authentication. From a compliance perspective it is also important that the system not allow for deconstruction of personal identities based on health records. As such, authentication plays an important role. An authentication module can optionally store login information and authenticate users against the blockchain information. As detailed below, the system can deploy decentralized IDs to enable selective disclosure of information or identity attributes. A user's public key may be stored on the blockchain which allows anyone to verify the authenticity of messages, transactions, or other data associated with that identity. A user in the ecosystem (advertiser, event sponsor, league, retailer, group etc.) may store identity-related data on the blockchain, such as verifiable claims, which are claims that have been cryptographically signed by a them and can be verified by others without revealing any additional information about the identity. Also, Zero knowledge proofs can be implemented to ensure that information about a user can be verified without sharing any personally identifiable information or protected information. Finally, verified credentials can also be deployed to ensure trustworthiness of the system.

A verified credential as part of this invention is a digital representation of a piece of identity-related data that has been cryptographically signed by a trusted authority. These credentials can include things like a person's name, date of birth, address, or medical record number or any other information as defined above relevant to EMR or clinical trials data. In a DID system, verified credentials are used to help establish trust between different parties. For example, when a user wants to prove their identity to a service provider (advertiser, loyalty rewards provider, retailer, etc.), they can present a verified credential that has been issued by a trusted authority such as insurance company, a government agency or any other trusted participant in the ecosystem. The service provider can then cryptographically verify the authenticity of the credential without having to rely on a centralized identity provider. These verified credentials can be stored on the blockchain, along with the decentralized identity and associated public keys. This allows them to be accessed and verified by anyone in the network without the need for a centralized intermediary. Additionally, because the credentials are cryptographically signed, they cannot be tampered with or altered without detection. Overall, verified credentials help to provide a more secure, private, and flexible approach to identity management, enabling individuals and organizations to assert and control their identities without relying on centralized intermediaries.

The NFT engine 110 offers a comprehensive array of features designed to enhance user experience and accessibility. Firstly, users can access location information directly from their devices. Additionally, they can log into various applications, including web or mobile applications, or 3D metaverse applications powered by gaming engines such as Unity or Unreal, from any communications device, regardless of their location. Optionally, geofencing can be configured around specific physical locations such as office venues, conference halls, convention centers, stadiums, arenas, marketplaces, districts, or any other region. This ensures that only participants within these real physical locations can interact with the system and access the benefits it provides.

Once users enter the geofenced area, they can interact with the application seamlessly. LogicWare 600, along with APIs and SDKs, enables the development of the application in various forms, including as a single web app, a native mobile app, or a monolithic client application. Additionally, various features can be split between the client and server ends of the application, with separate roles designated for users and admins.

The application can be triggered in multiple ways, such as scanning a QR code, accessing a specific URL displayed by the application or the venue, being automatically configured in the backend and presented to the user as part of another application, or being sent to the user as an SMS or message. Single sign-on (SSO) or a SAML assertion within an application is also supported.

Users have the flexibility to log in using their email, any social network, or single sign-on. They can associate their login details with a wallet address on a blockchain (a public key) while storing a corresponding private key. Optionally, the application can create a decentralized identity wallet for the user, with verified credentials mapped to the user's profile information. These verified credentials allow anyone to ascertain whether the decentralized identity is associated with a user without knowing any other personal information about the user.

Users can claim a digital asset by presenting the public key to the application configured with a smart contract. Payment can be made by fiat, crypto, or by redeeming a code. Additionally, whitelisted wallet addresses are allowed to mint an asset, while blacklisted wallet addresses are blocked by the application.

The application is governed by smart contracts, which can be EVM compatible or custom developed for specific blockchains such as Near or Solana. These smart contracts allow for various types of digital assets, including unique digital assets (ERC 721) or their equivalent on a non-EVM blockchain, copies of unique digital assets (ERC 1155) or their equivalent, mix and match of various other digital assets (ERC998) or their equivalent, and semi-fungible tokens (ERC3525) or their equivalent. They also allow for the rental of digital assets, with assets created via the smart contract being importable within a metaverse environment or a 3D environment powered by any gaming engine.

Optionally, the application may allow for smart contract deployment on the fly, creating a private key/wallet address pair for deployment of the smart contract, separate from any other wallet, known as a deployment wallet. This wallet does not hold any digital assets (NFTs) but may hold cryptocurrencies and can pay for transactions related to the digital assets created via the smart contract. Transactions may also be paid by an eventual buyer of the digital assets. Smart contracts can be automatically configured and deployed via API calls, on demand in real-time, and on a choice of blockchains or test network environments.

Digital assets created and stored may include creative elements such as pictures, audio, or video content, along with associated data related to the athlete, team, league, organization, school, university, or ecosystem partner for whose benefit the NFT may be created. All such data is associated with the creative elements and stored as metadata for the digital assets or the NFTs. All data and metadata may be stored centrally on any internet-connected server or in a decentralized manner using protocols such as IPFS or Arweave, among others. Digital assets may or may not be transferable to any other wallet address on the blockchain, with payments processed by storing the confirmation ID and token ID as proof of payment on the blockchain when the token is minted.

In one embodiment, the NFT can be issued within one geofenced location and redeemed for a transaction in another geofenced location, with additional rules or user requirements overlaid or in addition to geofencing rules.

The NFT engine 110, in an embodiment, mints and allocates cryptographic experiential tokens based on a location-based event and entitling the user to access an experience. In another aspect, token-gated access is granted to a resource at a location based on location triggered events and providing access to token-gated content in response to a user satisfying specified token criteria.

The system 100 may employ computer code modules (e.g., smart contracts) configured to manage the assignment of the non-fungible cryptographic tokens to designated digital wallet addresses associated with corresponding owners of the non-fungible cryptographic tokens. Digital wallets, or e-wallets or cryptocurrency wallets, can be in the form of physical devices such as smart phones or other electronic devices executing an application or electronic services, online services, or software platforms. Devices serving as digital wallets may include location-based services capabilities, e.g., GPS, UWB, BLE, WiFi, NFC, etc. and other capabilities. Digital wallets may provide a store of value or a credit or access to credit and may be in the form of a digital currency or involve a conversion to digital currency, tradeable digital asset, or other medium of exchange. The stored value accessible using a digital wallet may involve authentication to access ownership records or other indica stored in a digital ledger or DLT and requiring authentication and/or other decryption techniques to access the store of value. Parties may use digital wallets in conducting electronic financial transactions including exchanges of digital currency for goods and/or services or other considerations or items of value. Transactions may involve use of merchant or other terminal equipment and involve near field communication (NFC) features or other communication techniques and use a computer network. In addition, digital wallets may include identifying or authenticating information such as account credentials, loyalty card/account data, and driver's license information, and the transaction may involve communicating information contained or stored in the digital wallet necessary to complete intended transactions. As such, it is advantageous to create a decentralized identity for the user, so that their personal identity is secure and protected and that their privacy is not subject to unnecessary public scrutiny.

The location transaction module 120 includes a positioning module 310, a timer module 320, an NFT processing module 330 and a network module 340. The position module 310 tracks a current position using GPS, Wi-Fi, location sensors, or the like. NFTs can be identified by a current position, planned position, predicted position, or past position. The clock module 320 tracks a current time and further identifies NFTs related to the current time at the current position. The NFT processing module 330 interoperates with the NFT engine 110 as a back end using APIs and other communication techniques to record transactions. The network module 340 uses communication channels such as Ethernet or cellular to send and receive transaction data and other data. Additionally, AI agents can be used to facilitate automated data reporting service processes that may interact with any of the modules.

AI agents are software programs that employ artificial intelligence techniques to operate autonomously or semi-autonomously in a variety of environments, making decisions based on input data, predefined rules, machine learning models, or a combination of these methodologies. Typically, AI agents are capable of performing tasks independently without human intervention, adjusting their actions based on the analysis of incoming data. In this way they are an extension of an analytics engine and make it easy to take actions based on the underlying analysis for the data that they operate upon, such as performance or other informational data. These agents can improve their performance over time through learning mechanisms, based on the data itself. They adapt by observing outcomes and integrating new knowledge into their decision-making processes, retraining their algorithms in light of the new data. AI agents continuously perceive their environment and can react to changes in real-time or near real-time. Beyond reactive behaviors, AI agents can also exhibit goal-oriented behaviors, initiating actions based on predictive analytics and strategic planning. The design allows these agents to handle increasing amounts of work or to be easily expanded to manage complex or additional tasks. The output of AI agents can be information that can be represented as metadata and associated with an NFT. In one embodiment AI agents can be used to process data and create metadata that can be immutably recorded and attached to an NFT.

These AI agents can be implemented using a variety of technical frameworks and methodologies, including but not limited to:

Machine Learning and Deep Learning: Utilizing algorithms and neural networks to analyze data, recognize patterns, and make decisions.

Natural Language Processing (NLP): Enabling the understanding and generation of human language, facilitating interactions between humans and machines.

Robotics: Applying AI in mechanical or virtual robots, connected devices, IoT (Internet of Things) devices, etc. allowing for physical interaction with environments.

Expert Systems: Incorporating rule-based systems that mimic the decision-making abilities of a human expert.

Data Analysis Systems: Designed to interpret vast datasets efficiently and accurately to derive meaningful insights.

The geofence transaction module 120 can tie an NFT to a particular location. In some embodiments, an additional condition of time can be associated with the location. These assets may be created, stored, or accessed using location-based technologies such as GPS, geofencing, and augmented reality (AR), virtual reality (VR), or extended reality (XR) techniques. The data and metadata that is used to create the NFTs is stored in a distributed database or a blockchain. Alternatively, the data could be stored in regular databases, and permutations and various combinations of the data can be recorded as NFTs or stored on decentralized storage systems such as IPFS or Arweave, or a hash corresponding to the data can be stored on the blockchain.

One embodiment of location-based digital assets includes virtual experiences or games that are tied to specific locations and can only be accessed or played within one or more specified locations. Another embodiment of NFTs or digital assets are tied to a particular venue such as a football stadium, a convention center, or a basketball arena, and can only be redeemed, minted or transferred within a specified location. In still another embodiment, digital artwork or installations, or NFTs tied to the artwork or installations that are displayed at a specific location and can only be viewed in person at that location. Digital tokens or rewards that can be earned or redeemed at specific locations.

Location-based maps or guides can provide information about a specific location and can only be accessed at that location. The information may be stored as NFTs, or as metadata elements or the NFT, either on public storage such as IPFS or Arweave, or in private storage with a cloud service provider such as Google, Amazon, Microsoft, and the like.

Location-based digital assets can provide a unique and engaging way for businesses and individuals to interact with their surroundings and with each other. They can also help to enhance the physical world with digital content, and to create new opportunities for discovery and exploration.

AI agents can be used to facilitate automated data reporting service processes that may interact with the NFT processing module 320 automatically. Such automated data reporting service processes may include:
1. Database services designed to manage, query, and report data from relational, non-relational, or vectorized databases efficiently.
2. Business intelligence tools that collect and process large amounts of unstructured data from internal and external systems, prepare it for analysis, develop queries against that data, and create reports, dashboards, and data visualizations.
3. Data Warehousing Solutions that aggregate data from multiple sources, making it easier to provide comprehensive reporting and analysis. They often include tools for automated reporting and data analysis.
4. AI powered analytics platforms that use artificial intelligence to analyze data and generate reports. They can identify patterns, trends, and anomalies without human intervention.
5. AI agents that meet specific business needs, capable of extracting data from various sources, analyzing it using machine learning models, and generating tailored reports. These agents can be trained to provide insights specific to the business's operational, tactical, or strategic queries.

These automated data processing reporting services may also include spreadsheet tools with automation features, API based tools, cloud based reporting services, ETL (extract, transform, load) tools or any combination of the above.

The merging of the physical and digital worlds, also known as the “convergence” of these worlds, refers to the integration of digital technologies and experiences into the physical world, and vice versa. This merging has been made possible by advances in technologies such as the internet of things (IoT), augmented, virtual and extended reality, and location-based services.

The merging of the physical and digital worlds has many potential benefits. For individuals, it can provide new and enhanced ways of interacting with their surroundings, such as through location-based games and virtual experiences. For businesses, it can offer new opportunities for engagement and interaction with customers, such as through location-based marketing and digital storefronts. With NFTs, businesses can offer NFTs to their users within a specified location, typically geofenced, that serves as a proof of presence. This means that at the time the digital asset or NFT was created for the user, the user was present within that specified location. Since the NFT is an immutable record on the blockchain, it means that the record serves as a proof of physical presence of the user in that location. It will be obvious that the reverse logic is also true: that is, the NFT or digital asset may be offered, minted, transferred or sold to a user if they are absent from a particular location. The NFTs themselves can be based on ERC721, 1155, 998 (composable NFTs), or 4907 (NFT rentals), 4337 (gasless minting), 6551 (tokenbound accounts), or any other standards that may be developed or deployed. NFT standards could also be on any blockchain including but not limited to Ethereum, Polygon, Solana, Base etc. It may be noted that each of these NFTs is further associated with metadata and wallet address of the users prior to the NFT mint or transfer transaction. Accordingly, the NFT platform provides all the tools and resources to integrate with any location enabled application. An aggregate of all such NFTs could be showcased on a NFT marketplace. LogicWare allows for such a marketplace to be agnostic of the underlying blockchain, or NFT protocol and makes it easy for users to trade irrespective of the underlying protocol.

The merging of the physical and digital worlds can also create new challenges and potential risks. For example, the increasing reliance on digital technologies and networks can make individuals and businesses more vulnerable to cyber attacks and data breaches. Additionally, the integration of digital technologies into the physical world can raise ethical and privacy concerns, as individuals may be unaware of the extent to which their activities and behavior are being monitored and tracked. Almost all of this information can be recorded in the form of metadata of an NFT and immutably stored via a blockchain. It is advantageous to use NFTs because NFTs are stored with wallet addresses, which do not compromise the personal information of an individual. With wallet addresses the identity of users can remain anonymous. As such, a user's transactions and interactions need only be mediated by their wallet address and no other personally identifiable information. This provides users with enhanced privacy.

AI agents can create necessary reports, analytics, and actions that may provide business, marketing or any other benefits, including aggregating information from the physical and virtual locations where such data and experiences are stored or delivered.

NFTs can be designed to self-destruct after a period of time when an offer or a location information expires. Self destruction can be achieved by the user or the platform either by burning the NFT or by transferring it into a previously designated address where it may be locked.

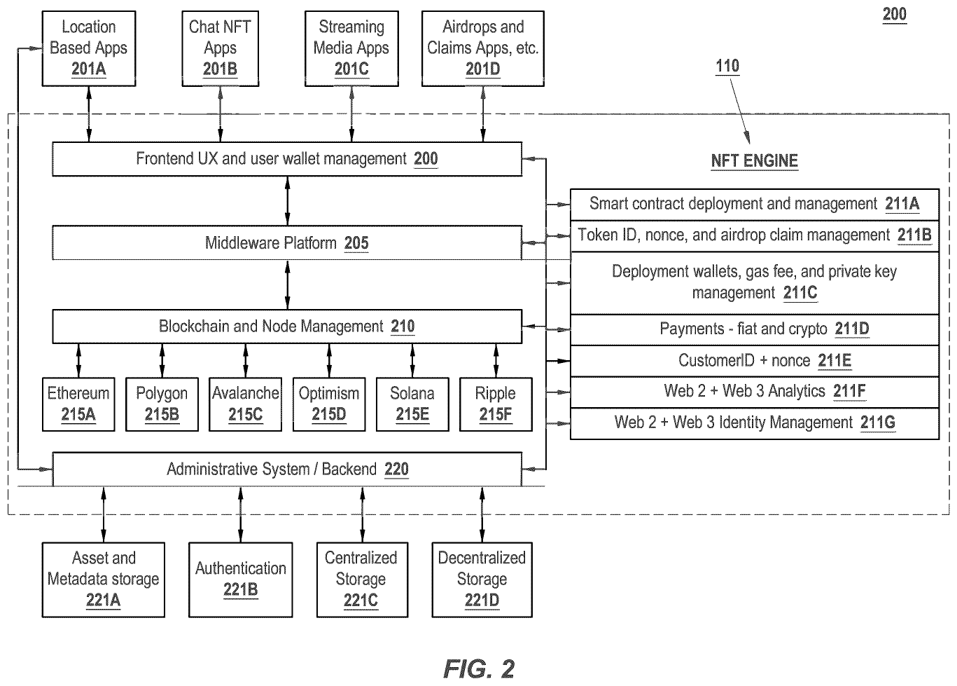

FIG. 2 illustrates one embodiment of a high-level architecture of the NFT Engine and its components. Various other components and modules can be added to the NFT Engine to accommodate customized NFT requirements.

The NFT Engine 110 interfaces with a variety of other software modules including the user experience modules and the core software infrastructure modules. In one embodiment, 201A is a location based application that is built using the NFT Engine 110. Location based apps 201A could also be a non location based application or any other generic application that provides blockchain and NFT functionality to the users. Location transaction apps 201B is another application or module. Other applications from a user experience perspective may be streaming media or digital avatar apps such as 201C or AirDrop and claims applications such as 201D there may be many more applications that can be built on top of the NFT engine. These applications interface directly with the NFT engine via the front end UX and user wallet management modules 200. In addition these applications also interface with an administrative system or a backend 220 which may be specific or customized for each application. The front end UX and user wallet management module 200 is connected to the NFT brewery middleware platform 205 which in turn connects to blockchain and node management modules 210. It may be noted that all the components of the NFT engine may also be directly interconnected with each other to ensure proper data flow, data and identity management and access controls for the users. The administrative system or backend 220 connects to various blockchains including but not limited to Ethereum 215A, Polygon 215B, Avalanche 215C, Optimism 215D, Solana 215E, Ripple 215F, Base or any other EVM or non-EVM blockchain via custom RPCs and APIs. In addition the back end 220 provides support for asset and metadata storage 221A, authentication 221B, centralized storage 221C, or decentralized storage 221D. Other modules and components of the NFT Engine include:
1. Smart contract deployment and management module (211A), that supports any underlying blockchain
2. TokenID, nonce, airdrop claim management modules (211B) to ensure individual transactions can be processed out of sequence as well in case certain transactions are held up in the execution queue.
3. Deployment wallets and scripts, wallet management including private key management and gas management (211C), with a variety of ways for managing private keys including encryption, utilizing key vaults, multi party computation techniques (MPC) or multi-signature wallet management.
4. Payments modules for both fiat as well as cryptocurrencies 211D via payment gateways, integrating recording the transaction results and status directly into the blockchain.
5. CustomerID and Nonce management for individual customers (211E), similar to the user side described above, to ensure that transactions by different customers do not queue up and can be processed independently.
6. Integrated web2 and web3 analytics (211F) to map transactional information of users to their wallets. In addition, AI techniques and algorithms can be utilized to infer behavioral information about users independent of their demographic information.
7. Integrated web2 and web3 identity management (211G) that allows for access controls to be implemented based on the digital wallets, ownership of media or avatars, or any other digital goods or identity modules including SSO, SAML, etc.

Web3 represents a shift towards a more decentralized, transparent, and user-centric internet, where individuals have greater control over their online interactions and data. Web3 refers to a next generation of the internet, where decentralized networks, blockchain technology, and cryptocurrencies are integrated to create a more open, secure, and user-centric internet. Unlike Web 2.0, which is characterized by centralized platforms and services controlled by large corporations, Web3 aims to decentralize the internet, giving users more control over their data and online interactions.

In Web3, users interact with decentralized applications (dApps) that run on blockchain networks, such as Ethereum, and communicate through peer-to-peer protocols. This enables trustless transactions, where intermediaries are eliminated, and transparency is ensured through the immutability of blockchain technology.

One of the key features of Web3 is the use of smart contracts, which are self-executing contracts with the terms of the agreement directly written into code. Smart contracts enable automated and tamper-proof agreements, facilitating various applications such as decentralized finance (DeFi), non-fungible tokens (NFTs), decentralized exchanges (DEXs), etc.

Immutable refers to the inability to modify or tamper with data once it has been recorded. Transactions and data recorded on a blockchain are immutable, which means that they cannot be altered or deleted retroactively. This immutability is achieved through cryptographic hashing and the decentralized consensus mechanisms employed by blockchain networks. The immutable nature of blockchains ensures data integrity, transparency, and an auditable trail of all activities, which is crucial for applications requiring tamper-resistant record-keeping and trustless interactions. Data can also be stored immutably over the InterPlanetary File System (IPFS), which uses content-addressing to store immutable data in a distributed file system. This complements the immutable data storage capabilities of blockchains. Data can be stored on IPFS instead of directly on a blockchain due to the significant storage constraints and costs associated with recording large amounts of data on most blockchain networks. By storing the data immutably on IPFS and recording just the content-addressed IPFS hash on the blockchain, applications can leverage the immutability and tamper-resistance of both systems while optimizing for efficient data storage.

Ingesting data is the process of importing assorted data files from one or more sources into a cloud-based or on-premise storage medium, a data warehouse, data mart, InterPlanetary File System (IPFS), decentralized storage network, or any other structured or unstructured database where it can be accessed and analyzed. This process involves extracting data from various sources, transforming it into a compatible format, and loading it into the designated storage or a processing system. Efficient data ingestion mechanisms are crucial for handling large volumes of data from multiple sources in real-time or batch modes. The ingested data can encompass various formats, including text, numerical data, audio, video, and multimedia content. The ingested data can originate from databases, log files, IoT devices, social media platforms, or any other data-generating source, enabling organizations to consolidate and derive insights from diverse data sets. Robust data ingestion pipelines ensure data integrity, scalability, and integration with downstream analytics and processing systems.

A backpack is a cryptographic construct that binds a user's digital identity, data, credentials, or any other digital assets to a non-fungible token (NFT) or other blockchain-based token. This account backpack NFT serves as a secure, portable representation of the user's identity, data, credentials, and other assets across different applications. By leveraging the immutability and trustless characteristics of blockchain technology, the account backpack provides users with self-sovereign control and management of their digital identity and assets within a unified repository while maintaining security, transparency, and an auditable record of account activity.

Binding refers to the cryptographic process of associating a user's digital identity, credentials, assets, or data with a specific blockchain token or non-fungible token (NFT). This binding establishes an inseparable link between the token and the account, ensuring that the account's contents are inextricably tied to the token's ownership and transfer. The binding mechanism leverages cryptographic primitives like digital signatures and hashing to create a secure and verifiable connection between the account data and the fungible or non-fungible tokens. Once bound, the account and its associated data can only be accessed, modified, or transferred by the rightful owner of the corresponding token, as established by the private key/wallet address pair, providing self-sovereign control over the digital assets, identity and credentials.

A series of NFTs may refer to a chronological sequence of recorded activities, actions, or occurrences. Each NFT that is created in the series may be appended as an immutable entry, preserving the order and integrity of the overall series. The series of NFTs therefore allows for a transparent and auditable log of all events that have transpired within a system or process. As such, the system ensures a verifiable history that cannot be retroactively modified, enabling trustworthy record-keeping and traceability of operational activities over time.

An interval represents a specific, finite period or window of time that is consumed or utilized in its entirety. An interval has a defined start and end point. Once an interval has been allocated or assigned for a particular purpose, it cannot be reused or reassigned until it has been fully consumed or expired. This property of intervals ensures exclusivity and prevents overlapping usage conflicts within the designated time window. For example, if data from a particular interval has been converted to an NFT for audit purposes, the same data may not be included in another interval for a second NFT, as it may lead to double counting of the resources utilized in the interval. Such double counting can lead to conflicts and destroy the integrity of the data.

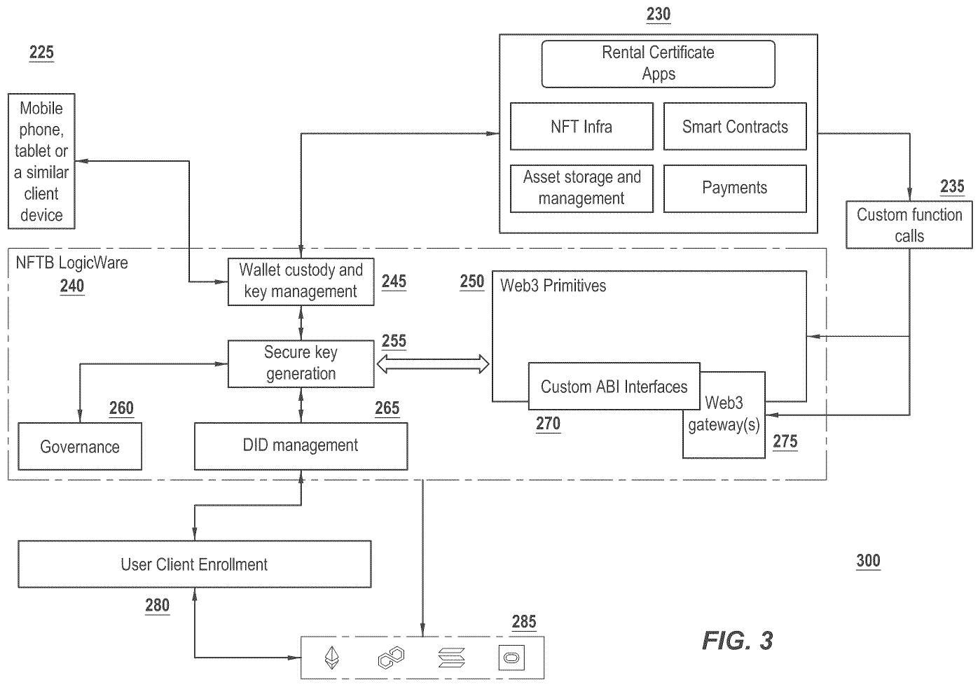

FIG. 3 illustrates an exemplary high level architectural view of a location-based application system embedded with customer support applications that can communicate with a mobile phone or other client device. Various other components and modules can be added to this architecture to accommodate customized NFT requirements.

The end user may log in into the platform using a mobile phone tablet or similar client device (225). The application running on the device interacts with the NFT middleware platform via the NFTB LogicWare (240). The LogicWare determines the wallet custody and key management protocol 245 that applies to the particular application (230) or the user and logs the user in into the application. If the user interacts with the application or dApp the first time, the custody and key management protocol 245 generates a new key pair using the secure key generation module 255 or the user and associates it with their identity. Optionally it may also associate the keys with a decentralized identity and issue verified credentials to the user. Additionally, LogicWare also creates or associates the governance policies that the user identity may be subject to. If the user is a returning user, the LogicWare retrieves the keys and based on the governance and access control rights, allows the user to access the application or the dApp. As depicted in FIG. 2 the application or dApp may consist of several components including smart contracts deployed via the module 211A or otherwise imported into the application, NFT infrastructure modules such as 211A, 211B, 211C, 211D, 211E, 211F, 211G, asset storage and management (221A, 221C, 221D), or payments (211D).

The application interfaces with the middleware and NFT engine via custom function calls APIs and SDKs 235. The NFT engine includes various web3 primitives, 250, that are interoperable building blocks that are highly reliable in executing transactions over a blockchain, communicate with backend 220 and frontend 200 systems, work with storage components (221C, 221D), utilize analytics from modules such as web2 and web3 analytics 211F, identify users using the identity management module 211G, secure the applications using authentication, identity management, or implement access controls with 211G, 211B or provide for a governance layer in combination with the governance module 260. The web3 primitives 250 also communicate with custom ABI interfaces 270 and web3 gateways 275 for deploying smart contracts to their respective blockchains, interacting with smart contracts, and executing the functions and instructions in the smart contracts.

In addition, the LogicWare optionally comprises a governance (260) and a Decentralized Identity (DID) management module (265). DIDs are an important part of securing identity and making it interoperable across both web2 and web3 platforms.

Applications in web3 are also referred to as dApps. Governance in decentralized applications (dApps) in and communities refers to the processes and mechanisms through which decisions are made and actions are taken within the decentralized ecosystem. In traditional centralized systems, governance is typically controlled by a central authority, whereas in decentralized systems, governance is distributed among network participants. In one embodiment, the decision making and governance is in part based on the decentralized identity of the users themselves, who interact with the dApp and the associated smart contracts with their wallets and their corresponding private keys. The Governance module 260 within the NFTB LogicWare allows for implementing various governance mechanisms and resource allocations. In conjunction with the DID management module 265, the governance module 260 also employs mechanisms to prevent Sybil attacks or other malicious attacks on the system, such as, where an individual may create multiple identities to gain disproportionate influence for voting purposes. Sybil resistance mechanisms can include reputation systems, stake-weighted voting, or identity verification to ensure that governance decisions are made by genuine participants.

The DID management module (265) is a part of the web2 and web3 identity management module (211G) described above. The module utilizes methods for decentralized technologies, such as distributed ledgers (e.g., blockchain) or peer-to-peer networks, to enable the creation, management, and verification of DIDs and associated digital identities. As such, the DID created for any user can be used as an identity across any blockchain and helps identify the user on the application, without compromising the user's actual identity or demographic information. The users retain full control over their DID and can choose to lock and selectively share their information using their DIDs. In particular, this is an efficient way of combining various private blockchain systems favored by enterprises, with the public blockchain systems. With a DID, a user can retain the same wallet address to make transactions over any supported blockchain.

Various blockchains may have different ways to monitor and govern the identity of the users. In order to map the identity from one system to another, it may be necessary to homogenize the identity across the multiple platforms by implementing a client enrollment module, 280, to create a system where the identities from one system may map directly to an identity on another system, without the need for any user intervention. For example, when making a private blockchain system to be compatible with a public blockchain such as Ethereum, Polygon or Solana, it may be essential to create a user (client) enrolment into the Hyperledger based system and map it to the private keys for the eventual user of the system.

FIG. 2C illustrates the use of verified credentials (VCs) for authentication into the ecosystem of applications for access control or user onboarding features.

When a user logs in to the platform using a mobile phone, tablet, desktop, or a similar device, 231, the onboarding application 236 or dApp issues a verified credential (VC) to the user. It may be noted that the VC may be issued by a third party application separately and imported into the client application. These VCs allow the user to access other connected applications or dApps that the user may wish to, such as loyalty programs, using their decentralized identity. As such, verified credentials (VCs) act as authenticating mechanisms for users to use the appropriate wallets as a proxy for their identity on the system. A user may have multiple wallets associated with their identity. When a user logs in to the application or dApp, the LogicWare 256 identifies the appropriate identity to use and retrieves the appropriate keys from the key management system 251. This in turn allows the application or dApp 246 to transact with the blockchain using the appropriate identity and the private keys associated with them. A user's public key may be stored on the blockchain which allows anyone to verify the authenticity of messages, transactions, or other data associated with that identity.

Automated data reporting service processes such as artificial intelligence agents (or AI agents) are software programs or algorithms designed to perform specific tasks autonomously, making decisions and taking actions based on predefined rules, learning from data, or adapting through machine learning techniques. AI agents can leverage data, including data associated with NFTs, to perform various tasks and processes. AI agents are used in various applications across different domains, including:

Virtual Assistants: AI agents like Siri, Alexa, and Google Assistant interact with users, understand natural language, and perform tasks such as answering questions, setting reminders, and controlling smart home devices.

Chatbots: AI agents used in customer service and support systems to interact with users, answer questions, provide assistance, and handle simple tasks.

Recommendation Systems: AI agents analyze user behavior and preferences to provide personalized recommendations for products, movies, music, and content.

AI agents can be simple or complex, depending on the task they are designed to perform. They can also range from rule-based systems to advanced machine learning models capable of learning from data and improving their performance over time

AI agents can perform a wide range of tasks across various domains, including:

Natural Language Processing (NLP): AI agents can translate text or speech from one language to another (Language Translation), analyze text data to determine the sentiment expressed (Sentiment Analysis), and identify and classify entities mentioned in text data, such as names of people, organizations, or locations (Named Entity Recognition (NER));

Computer Vision and Object Detection: AI agents can identify and locate objects within images or videos;

Image Classification: AI agents can classify images into predefined categories;

Facial Recognition: AI agents can recognize and identify human faces in images or videos;

Data Analysis and Predictive Modeling: AI agents can analyze historical data to make predictions about future events or trends (Predictive Analytics), identify unusual patterns or outliers in data (Anomaly Detection) and forecast future values based on historical time series data (Time Series Forecasting);

Healthcare: AI agents can assist healthcare professionals in diagnosing diseases and medical conditions based on patient data. and can analyze patient data to recommend personalized treatment plans;

Finance: AI agents can analyze financial data and facilitate transactions, identify fraudulent activities by analyzing financial transactions and assess the creditworthiness of individuals or businesses based on their financial history;

Virtual Reality (VR) and Augmented Reality (AR): AI agents can enhance user experiences in VR and AR applications by providing intelligent interactions and personalized content;

Cybersecurity: Intrusion Detection: AI agents can detect and respond to security threats in computer networks;

Malware Detection: AI agents can identify and neutralize malicious software; and

Content Creation: AI agents can generate text, images, music, and other forms of content automatically.

AI agents can be linked to NFTs in several ways:

Ownership and Authentication: NFTs can be used to prove ownership and authenticate AI agents. Each AI agent can be represented by a unique NFT, and ownership of the agent can be transferred via the NFT;

Training Data and Model: NFTs and their associated metadata can represent the training data used to train the AI agent or the model itself. This can ensure the transparency of the AI's capabilities and its training data;

Royalties and Intellectual Property Rights: NFTs can also be used to manage royalties and intellectual property rights associated with AI agents. Creators can receive royalties whenever their AI agents are used;

Marketplaces and Trading: NFT marketplaces can facilitate the trading of AI agents. Creators can sell, buy, or exchange AI agents using NFTs, with the ownership of the AI agent being transferred along with the NFT;

Customization and Upgrades: NFTs can represent unique features, attributes, or upgrades of AI agents. For example, owners can share or grant temporary access to NFTs to advertisers or approved third parties to represent these features and allow them to apply AI agents to customizing or personalizing communication according to preferences; and

Provenance and History: NFTs can store the provenance and history of an AI agent, including its previous owners, usage history, and any modifications made to it.

By linking AI agents to NFTs, creators can ensure ownership, authenticity, and traceability, while also providing a platform for trading, sharing, accessing, customizing, and monetizing data accessible by AI agents.

Various cloud vendors provide platforms and services that support the development and deployment of AI agents. These cloud vendors are continuously adding support features, improved capability and services in support of their cloud offerings. Some of the major providers include Amazon Web Services (AWS) (Amazon Lex: A service for building conversational interfaces into any application using voice and text; Amazon Polly: A service that turns text into lifelike speech, allowing users to create applications that talk; Amazon Rekognition: A service for adding image and video analysis to applications; Amazon Comprehend: A natural language processing (NLP) service for understanding the content of text documents; Amazon SageMaker: A fully managed service that provides developers and data scientists with the ability to build, train, and deploy machine learning (ML) models); Microsoft Azure (Azure Bot Service: A service that enables you to build intelligent, enterprise-grade bots that help enrich the customer experience while reducing costs; Azure Cognitive Services: A set of APIs, SDKs, and services available to help developers build intelligent applications without having direct AI or data science skills; Azure Machine Learning: A cloud-based environment that a user can use to train, deploy, automate, and manage machine learning models0; Google Cloud Platform (GCP) (Google Dialogflow: A natural language understanding platform that makes it easy to design and integrate a conversational user interface into mobile app, web application, device, bot, interactive voice response system, and more; Google Cloud Speech-to-Text and Text-to-Speech: APIs for converting audio to text and vice versa; Google Cloud Vision API: Enables developers to understand the content of an image by encapsulating powerful machine learning models in an easy-to-use REST API; and Cloud Natural Language API: Provides natural language understanding technologies to developers).

These cloud vendors offer a wide range of AI and machine learning tools and services, enabling developers to create sophisticated AI agents, chatbots and virtual assistants.

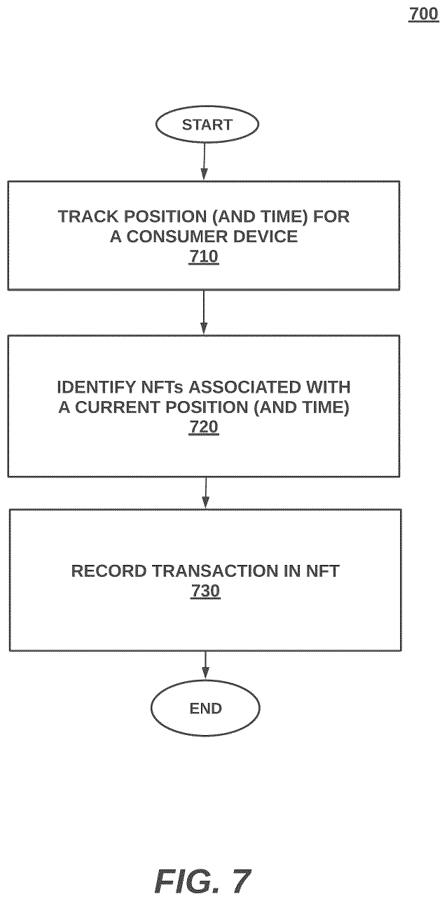

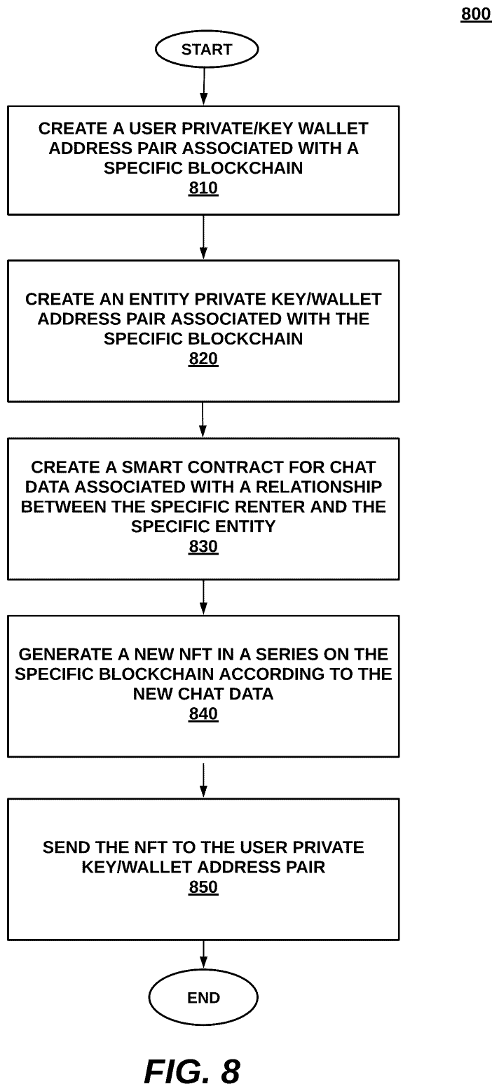

### III. Methods for Location-Based NFTs (FIG. 7-8)

FIG. 7 is a high-level flow diagram illustrating a method 700 for recording user data at a particular location, and can further segregate based on a particular time at the location, according to one embodiment. The method 700 can be implemented by, for example, system 100 of FIG. 1. At step 710, a user position and time is tracked with a smartphone or other device or mechanism. At step 720, NFTs associated with a current position are identified in real-time and can be updated based on movement. Certain NFTs may relate to a current time at the current position. At step 730, transactions are recorded in the associated NFTs.

FIG. 8 is a more detailed flow diagram illustrating an alternative method 800 for recording user data at a particular location, and can further segregate based on a particular time at the location, according to one embodiment.

At step 810, a user private key/wallet address pair associated with a specific user to interact with the system si created. The user private key/wallet address pair is associated with a specific blockchain.

At step 820, an entity private key/wallet address pair associated with one or more of the specific locations to interact with the smart contract is created and store at least a portion of the location data associated with the specific user on the blockchain.

At step 830, a smart contract for location data associated with a relationship between a specific user and at least one specific location in a location history database is created.

At step 840, a new NFT in a series on the specific blockchain is generated according to new location data using the smart contract and authorized by the entity private key/wallet key pair of the specific user or the one or more specific locations to activate the location history.

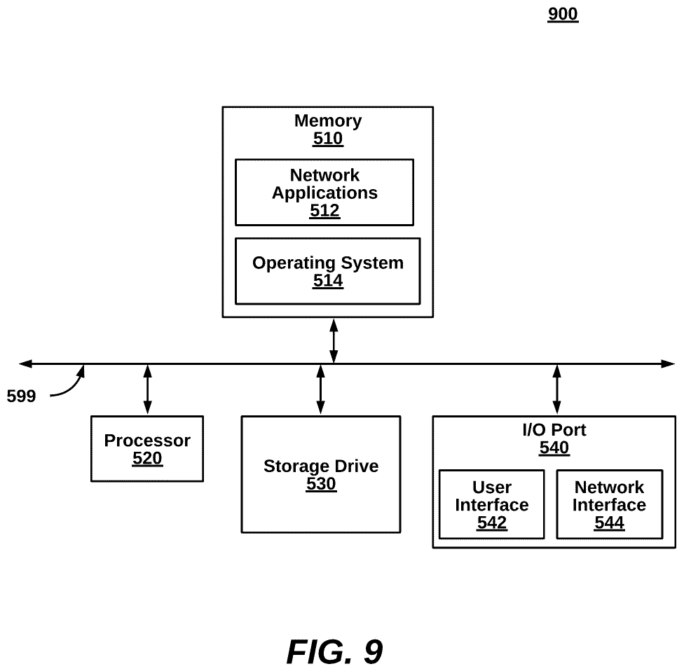

### III. Computing Device for Location-Based NFTs (FIG. 9)

FIG. 9 is a block diagram illustrating a computing device 500 for use in the system 100 of FIG. 1, according to one embodiment. The computing device 500 is a non-limiting example device for implementing each of the components of the system 100, including NFT engine 110, location transaction module 120 and a consumer device 130. Additionally, the computing device 500 is merely an example implementation itself, since the system 100 can also be fully or partially implemented with laptop computers, tablet computers, smart cell phones, Internet access applications, and the like.

The computing device 500, of the present embodiment, includes a memory 510, a processor 520, a hard drive 530, and an I/O port 540. Each of the components is coupled for electronic communication via a bus 599. Communication can be digital and/or analog, and use any suitable protocol.

The memory 510 further comprises network access applications 512 and an operating system 514. Network access applications can include 512 a web browser, a mobile access application, an access application that uses networking, a remote access application executing locally, a network protocol access application, a network management access application, a network routing access applications, or the like.

The operating system 514 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7-11), Linux, HP-UX, UNIX, Sun OS, Solaris, Mac OS X etc, Alpha OS, AIX, IRIX32, or IRIX84. Other operating systems may be used. Microsoft Windows is a trademark of Microsoft Corporation.

The processor 520 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 520 can be single core, multiple core, or include more than one processing element. The processor 520 can be disposed on silicon or any other suitable material. The processor 520 can receive and execute instructions and data stored in the memory 510 or the hard drive 530.

The storage device 530 can be any non-volatile type of storage such as a magnetic disc, EPROM, Flash, or the like. The storage device 530 stores code and data for access applications.

The I/O port 540 further comprises a user interface 542 and a network interface 544. The user interface 542 can output to a display device and receive input from, for example, a keyboard. The network interface 544 connects to a medium such as Ethernet or Wi-Fi for data input and output. In one embodiment, the network interface 544 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C #, Oracle® Java, Javascript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

We claim:

1. A computer-implemented method in a system, on a data communication network, for providing immutable location history transactions within a non-fungible cryptographic token (NFT) based location history certificate, the method comprising:
creating a user private key/wallet address pair associated with a specific user to interact with the system, wherein the user private key/wallet address pair is associated with a specific blockchain;
creating an entity private key/wallet address pair associated with one or more of the specific locations to interact with the smart contract and store at least a portion of the location data associated with the specific user on the blockchain;
creating a smart contract for location data associated with a relationship between a specific user and at least one specific location in a location history database;
generating a new NFT in a series on the specific blockchain according to new location data using the smart contract and authorized by the entity private key/wallet key pair of the specific user or the one or more specific locations to activate the location history; and
sending the NFT to the user private key/wallet address pair.

2. A non-transitory computer-readable medium in a rental verification system, on a data communication network, storing code that when executed, performs a method for providing immutable location history transactions within a non-fungible cryptographic token (NFT) based location history certificate, the method comprising:
creating a user private key/wallet address pair associated with a specific user to interact with the system, wherein the user private key/wallet address pair is associated with a specific blockchain;
creating an entity private key/wallet address pair associated with one or more of the specific locations to interact with the smart contract and store at least a portion of the location data associated with the specific user on the blockchain;
creating a smart contract for renter data associated with a relationship between a specific user and at least one specific location in a location history database; and
generating a new NFT in a series on the specific blockchain according to new location data using the smart contract and authorized by the entity private key/wallet key pair of the specific user or the one or more specific locations to activate the location history.

3. A location system, on a data communication network, for providing immutable location history transactions within a non-fungible cryptographic token (NFT) based location history certificate, the location system comprising:
a processor;
a network interface communicatively coupled to the processor and to a data communication network; and
a memory, communicatively coupled to the processor and storing:
a first module create a user private key/wallet address pair associated with a specific user to interact with the system, wherein the user private key/wallet address pair is associated with a specific blockchain;
a second module to create an entity private key/wallet address pair associated with one or more of the specific locations to interact with the smart contract and store at least a portion of the location data associated with the specific user on the blockchain;
a third module to create a smart contract for renter data associated with a relationship between a specific user and at least one specific location in a location history database; and
a fourth module to generate a new NFT in a series on the specific blockchain according to new location data using the smart contract and authorized by the entity private key/wallet key pair of the specific user or the one or more specific locations to activate the location history.
